(19) United States
(12) Patent Application Publication
(10) Pub. No.: US 2026/0367882 A1
(43) Pub. Date: Nov. 19, 2026

(54) EFFICIENT CODE GENERATION

(71) Applicant: SAP SE, Walldorf (DE)

(72) Inventors: Shrinivas KAZA, Danville, CA (US); Raghuveer KANNEGANTI, Prosper, TX (US); Parameswara Rao TATINI, Antioch, CA (US); Sheetal RAJGURE, Austin, TX (US); Neda EDALAT, San Jose, CA (US); Ryan SKORUPSKI, Bellevue, WA (US); Pravir CHUGH, Los Angeles, CA (US); Taiwo ALABI, Berkeley, CA (US)

(21) Appl. No.: 19/210,148

(22) Filed: May 16, 2025

(51) Int. Cl. G06F 8/35; G06F 8/36

(52) U.S. Cl. CPC G06F 8/35; G06F 8/36

(57) ABSTRACT

A system and method include reception of a text query, generation of a first vector based on the text query, identification of a stored second vector which is similar to the first vector, generation of a first prompt including the text query, a code portion associated with the second vector, a summary of the code portion and an instruction to generate code, reception of a first code snippet from a text generation model in response to the first prompt, generation of a second prompt including the text query, the code portion, the summary of the code portion, the first code snippet and the instruction to generate code, reception of a second code snippet from the text generation model in response to the second prompt, concatenation of the first code snippet and the second code snippet, and returning of the concatenated first code snippet and second code snippet.

### BACKGROUND

Modern software development often involves navigating and understanding large, complex codebases. Traditional techniques for identifying relevant portions of such codebases primarily rely on keyword matching, which is inadequate for probing nuanced semantic relationships within the code. Even if relevant code portions are identified, significant time and expertise are often required for comprehension thereof.

Large Language Models (LLMs) such as generative pre-trained transformer models (GPTs) have been recognized as potentially useful advancements in the field of code development. Such models may answer questions regarding source code and may also be used to generate source code in some instances. However, existing LLM-based coding assistants face significant challenges when applied to enterprise-scale codebases.

First, the input and output context windows of LLMs are limited to particular maximum numbers of tokens. The input window limitation restricts the amount of code that can be analyzed concurrently. This restriction hinders the ability to understand code in its entirety. The output window limitation restricts the amount of code which can be generated.

Moreover, although LLMs excel at recognizing patterns within text, their understanding of code semantics remains limited, particularly with respect to programming languages exhibiting intricate object-oriented structures and complex dependencies (e.g., Java, C++, C#). This limitation impacts the accuracy and relevance of code analysis and code generation.

It has been further suggested to employ retrieval-augmented generation (RAG) techniques to add context from a relevant codebase to code-related LLM prompts. Existing RAG techniques struggle to efficiently index and represent the vast information contained within large codebases, making it difficult to retrieve relevant context based on user queries.

Systems are needed to efficiently summarize, index, retrieve, and generate code associated with large-scale enterprise codebases.

### BRIEF DESCRIPTION OF THE DRAWINGS

FIG. 1 illustrates a system for providing coding assistance according to some embodiments.

FIG. 2 is a flow diagram of a process for indexing a codebase according to some embodiments.

FIG. 3 illustrates the prompting of a text generation model to generate a method summary according to some embodiments.

FIG. 4 illustrates a vector database according to some embodiments.

FIG. 5 is a flow diagram of a process for generating code based on a user query and an indexed codebase according to some embodiments.

FIG. 6 is a user interface presenting a user query according to some embodiments.

FIG. 7 illustrates the prompting of a text generation model to generate a code snippet according to some embodiments.

FIG. 8 illustrates the prompting of a text generation model to generate a second code snippet according to some embodiments.

FIG. 9 is a user interface presenting a user query according to some embodiments.

FIG. 10 is a user interface presenting a user query and a summary of a method according to some embodiments.

FIG. 11 is a diagram of a cloud-based implementation according to some embodiments.

### DETAILED DESCRIPTION

The following description is provided to enable any person in the art to make and use the described embodiments. Various modifications, however, will be readily-apparent to those in the art.

Some embodiments employ a unique embedding generation process that captures rich semantic information from a codebase and facilitates accurate retrieval of relevant methods and metadata from the codebase based on a user query. The methods and metadata may be included within an LLM prompt requesting generation of a code segment corresponding to the user query. Additionally, embodiments include techniques for overcoming output window limitations inherent in current LLMs, enabling seamless generation of arbitrarily large code segments.

Embodiments enable developers to efficiently locate relevant code snippets within massive codebases using natural language queries, significantly improving code discoverability and reducing time spent on code searching. Rapid and accurate generation of complex code segments also serves to reduce development time and effort. Embodiments provide detailed method summaries to facilitate deep understanding of code functionality and underlying logic, thereby aiding in code maintenance and evolution. Moreover, embodiments can be readily scaled to accommodate the evolving programming languages and needs of large enterprises.

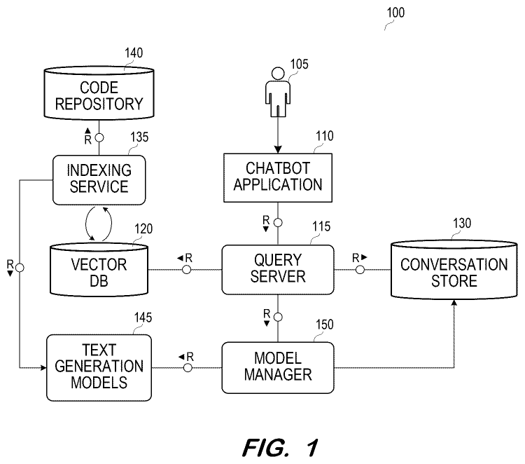

FIG. 1 illustrates system 100 for providing coding assistance according to some embodiments. Each of the illustrated components may be implemented using any suitable combination of local, on-premise, cloud-based, distributed (e.g., including distributed storage and/or compute nodes) computing hardware and/or software that is or becomes known. Each component described herein may be executed by one or more physical and/or virtualized servers.

Two or more components of FIG. 1 may be co-located. In some embodiments, two or more components are implemented by a single computing device. One or more components may be implemented by a cloud service (e.g., Software-as-a-Service, Platform-as-a-Service). A cloud-based implementation of any components of FIG. 1 may apportion computing resources elastically according to demand, need, price, and/or any other metric. Each component may be executed by an execution environment comprising one or more servers, virtual machines, clusters of a container orchestration system, etc. Such an execution environment may provide an operating system, services, I/O, storage, libraries, frameworks, etc. to applications executing therein.

User 105 inputs text and commands to chatbot application 110 as is known in the art. Chatbot application 110 may comprise a component of another application, such as an integrated development environment (not shown) used to facilitate code development. User 105 may operate a user device (not shown) to access and interact with chatbot application 110. The user device may comprise, for example, a laptop computer, a desktop computer, a smartphone, or a tablet computer.

According to some embodiments, chatbot application 110 is a front-end application and query server 115 is a corresponding back-end application. A user device may execute a Web browser which executes chatbot application 110 and provides user queries received by chatbot application 110 to query server 115.

Query server 115 may perform several functions. Query server 115 retrieves information relevant to the user query from vector database 120 and from conversation store 130. According to some embodiments, query server 115 generates an embedding representing a received user query and conducts a similarity search to determine whether vector database 120 or conversation store 130 include embeddings which are similar to the generated embedding. Query server 115 then retrieves any information stored in vector database 120 or conversation store 130 in association with the similar embeddings.

An embedding is a multi-dimensional numerical vector which is intended to capture the semantic and syntactic meaning of text. Ideally, embeddings of semantically-similar text are close to one another in vector space, and embeddings of semantically-dissimilar text are far from one another in vector space. Query server 115 may generate an embedding by providing the user query to an embedding model (not shown) to generate a multi-dimensional vector representing the semantics of the user query.

Vector database 120 may store portions of source code (and/or links thereto), and for each portion of source code, a corresponding summary and embedding. Indexing service 135 may populate vector database 120 based on content of code repository 140. Code repository 140 may comprise a code repository (e.g., GitHub) including one or more large-scale enterprise codebases written in Java, JavaScript, Go, Rust, Pearl, Python, C, C#, C++, etc.

According to some embodiments, indexing service 135 acquires code from code repository 140 and splits the code into methods, functions, etc. Indexing service 135 parses each method to determine information about the method. The information may include but is not limited to the method body, access modifiers, parameter lists, developer comments, documentation, parent class information including class name, inheritance hierarchy, and class-level comments, exceptions thrown, exceptions handled, and return statement types and values.

For each method, indexing service 135 prompts one of text generation models 145 to generate a summary thereof. The prompt may include the method code and the information about the method determined by service 135. The summary is intended to accurately describe the meaning and functionality of the method.

Text generation models 145 may comprise one or more LLMs conforming to a transformer architecture. Non-exhaustive examples of an LLM include GPT-4, LaMDA, Claude Sonnet, Gemma, Mistral, Mixtral, Llama, Gemini-1.5-pro, and Gemini-1.0-pro. A transformer architecture may include, for example, embedding layers, feedforward layers, recurrent layers, and attention layers. An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens of the input text in sequence to capture the relationships between the tokens. Attention layers may employ self-attention or flash-attention mechanisms which are capable of considering different parts of input text and/or the entire context of the input text to generate output text. Generally, each layer includes nodes which are connected to the input of nodes of a subsequent layer to form a directed and weighted graph. Each node receives input, changes its internal state according to that input, and produces an output depending on the input and internal state.

Text generation models 145 may be implemented by, for example, executable program code, a set of hyperparameters defining a model structure and a set of corresponding weights, or any other representation of an input-to-output mapping which was learned as a result of the training. Each of models 145 may be publicly available or deployed within a trusted landscape. Similarly, each of models 145 may be trained based on public and/or private data.

Indexing service 135 inputs each method summary into a text embeddings model to generate an embedding for each summary. The embeddings encapsulate semantic information of the summaries. Accordingly, methods with similar functionalities, even if implemented differently or located in disparate parts of the codebase, are clustered closely together in the embedding space. The embeddings thereby allow for similarity comparisons against the methods based on their meaning and functionality. Indexing service 135 stores each generated embedding in vector database 120 in association with its corresponding summary and method.

Conversation store 130 stores data generated during operation of system 100. The data may include previously-received user queries, embeddings of the user queries, LLM responses and associated LLM model/version, session identifiers, session start and end times, session users, session metadata, response latency, and LLM token usage. The data of conversation store 130 may enable efficient retrieval of conversation context, query similarity matching, session continuity, and performance monitoring.

As described above, query server 115 generates an embedding for a user query received from chatbot application 110. Query server 115 requests vector database 120 and conversation store 130 to perform a similarity search to identify stored embeddings which are semantically similar to the user query embedding. In response, vector database 120 and conversation store 130 return information associated with such semantically similar embeddings to query server 115. In the case of vector database 120, the information may include, for each identified embedding, method code and a method summary. Conversation store 130, on the other hand, may return a user query and an LLM response associated with each identified embedding.

Query server 115 passes a received user query and any information retrieved from vector database 120 and conversation store 130 to model manager 150. Model manager 150 generates a prompt (e.g., consisting of a system prompt and a user prompt) which includes the user query and includes the retrieved information as context to the query. Depending on the user query, the prompt may request generation of an answer to a question regarding the codebase, generation of code, or generation of other code-related responses.

The prompt is transmitted to one of models 145. Model manager 150 may select a particular one of models 145 to which to transmit the prompt based on any number of factors. These factors may include, for example, an input or output token limit, a desired latency, an associated cost, and model availability,

The selected model 145 operates based on its training to generate a response. The response is returned to model manager 150. Model manager 150 returns the response to query server 115. Model manager 150 may also store the response and associated metadata in conversation store 130 for future retrieval as described above. Query server 115 returns the response to user 105 via chatbot application 110.

According to some embodiments, the response received from the text generation model 145 indicates that it is incomplete. For example, the prompt transmitted to the model 145 may request generation of code. The model 145 generates the requested code until the size of the generated code reaches an output token limit of the text generation model 145. The model 145 then returns the generated code to model manager 150 along with an indication that the response is incomplete.

Upon determining that the response is incomplete, model manager 150 generates a new prompt which includes user query, code and information of the prior prompt as well as the code which was previously returned by the model 145. The new prompt asks the model 145 to continue code generation from the point at which the code generation was last terminated. This process may repeat several times to iteratively generate a code segment whose size far exceeds the output token limit of the model 145. In this regard, the input token limit of the model 145 is assumed to significantly exceed its output token limit. For example, the output token limit may be 8k while the input token limit may be 128k, 1 M, etc. The iteratively-generated code segment is the returned to user 105.

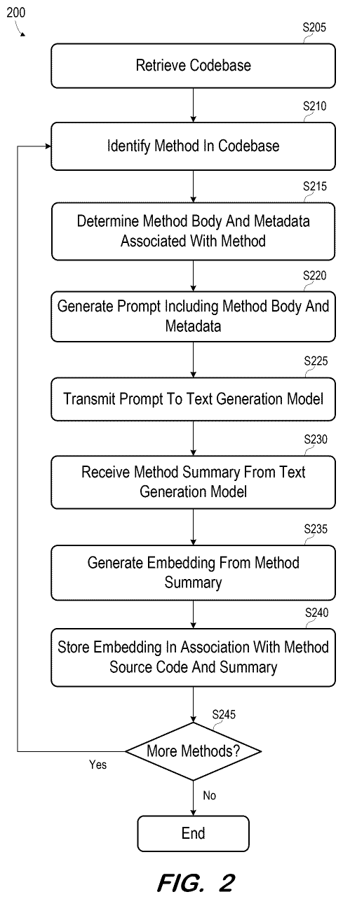

FIG. 2 comprises a flow diagram of process 200 for indexing a codebase according to some embodiments. Process 200 may be performed by an indexing service such as indexing service 135, but embodiments are not limited thereto.

Process 200 and the other processes described herein may be performed using any suitable combination of hardware and software. Software program code embodying these processes may be stored by any non-transitory tangible medium, including a fixed disk, a volatile or non-volatile random-access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

A codebase is retrieved at S205. The codebase may be retrieved from a repository such as a version control system and may be associated with one or more software applications or platforms. The retrieved codebase may comprise all source code for a particular software project, including all the files, scripts, libraries, and assets needed to build and maintain the software project. In addition to code, the codebase may include configuration files, documentation, tests, images, fonts, etc.

Next, at S210, methods in the codebase are identified. S210 may initially include normalization of the codebase. Normalization may include generic cleanup steps applicable to code of all programming languages, such as conversion of tabs to spaces, removal of trailing whitespaces, standardization of line endings to \n, and removal of blank lines. Additional normalization steps may be applied based on the programming language of the code to be normalized. The language programming may be detected based on file extensions, specific keywords or syntax patterns. The additional normalization steps may include block formatting (e.g., consistent brace styles for Java or proper indentation for Python), enforcing semicolons or colons where required, and removing unused imports or variables. Moreover, tools such as prettier, black, or clang-format may be used to ensure formatting consistency (e.g., naming conventions, indentation size, etc.) across supported languages.

Embodiments may employ a code splitter script at S210 to split the normalized code into code portions corresponding to respective methods. In one example, Java source code is split into an Abstract Syntax Tree (AST) representation identifying classes, methods, comments, and other relevant code elements. At S215, a body of an identified method (i.e., the code and other text of the method) is determined. Also determined at S215 is other information regarding the method such as method signature, comments, access modifiers, parameter lists, developer comments, documentation, class-level comments, exceptions thrown, exceptions handled, return statement types and values, and parent class information including class name, inheritance hierarchy, general/ global headers, description and utility.

A prompt is generated at S220, including the method body and the metadata. The prompt is intended to prompt a text generation model to generate a summary of the method. The prompt may comprise a system prompt of instructions to the model and a user prompt which includes the method body and the metadata. The prompt may instruct the model to generate a summary which includes the functionality of the method, its parent class context, including inheritance relationships and class-level documentation, exception handling details, including thrown and handled exceptions, and an analysis of the return statement which includes the types and potential values returned by the method.

In one non-exhaustive example, the prompt includes the following text:

“You are a software code summarizer. I will provide you with the full text of a method in a programming language. Your task is to:
Read the entire method to understand the context and purpose of its implementation.
Generate a concise summary of the method's functionality. The summary should:
   Clearly describe the method's purpose.
   Highlight its key inputs (parameters), outputs (return values), and any significant behavior or logic.
   Mention any notable dependencies, such as interactions with other methods or external classes.
      Here is the method code:
[Insert the method code here]
   Here are additional metadata information:
[Insert metadata information here]
   Ensure the summary is professional and to the point.”

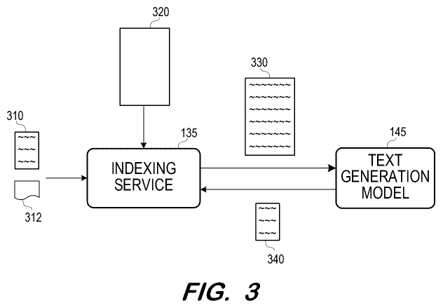

The prompt is transmitted to a text generation model at S225 and a summary of the method is received therefrom at S230. FIG. 3 illustrates use of a text generation model to generate a method summary according to some embodiments of S225 and S230. Indexing service 135 uses method body 310 and associated metadata 312 extracted as described above. Indexing service 135 uses prompt template 320 such as the above prompt text, populates prompt template 320 with method body 310 and metadata 312 to generate prompt 330 and transmits prompt 330 to text generation model 145. Text generation model 145 generates and returns summary 340 based on prompt 330.

Next, at S235, an embedding is generated from the method summary. The embedding is intended to encapsulate semantic information of the summary. The embedding may be generated by inputting the summary into a text embeddings model. of the summaries. The embedding is stored in a vector database at S240 in association with the summary from which it was generated and the code of the method from which the summary was generated.

Next, at S245, it is determined whether the codebase includes additional methods. If so, flow returns to S210 and continues as described above to generate and store a summary and an embedding for a next method. Flow cycles in this manner between S210 and S245 until it is determined at S245 that no methods remain to be analyzed.

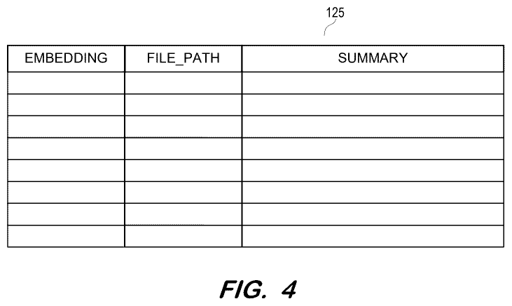

FIG. 4 illustrates vector database 125 generated by process 200 according to some embodiments. Embodiments are not limited to the fields of database 125. Vector database 125 includes a plurality of embeddings. Each of the embeddings represents either a method, a function, or the basic unit of a functional codebase and is associated with a summary of the method as described above. Each embedding is also associated with a filepath at which the code of its method is located. Accordingly, upon identifying an embedding from vector database 125, a summary of its corresponding method and the code of the method itself may be easily retrieved.

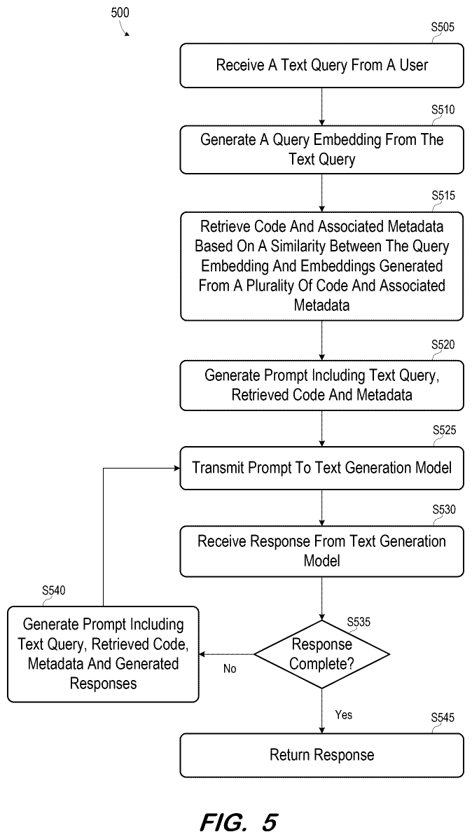

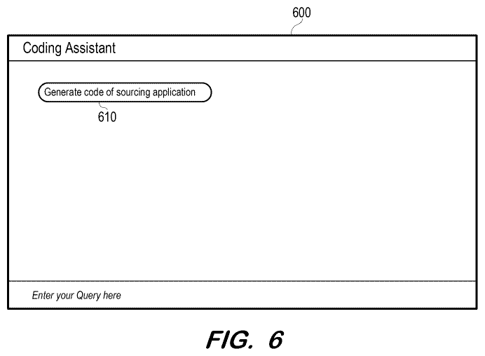

FIG. 5 is a flow diagram of process 500 for generating code based on a user query and an indexed codebase according to some embodiments. Initially, a text query is received from a user at S505. FIG. 6 illustrates user interface 600 of an application from which a text query may be received at S505. A user may access interface 600 via a Web browser and/or via a link provided by another application such as a launchpad. The user may be authenticated prior to receiving user interface 600. As shown, the user has entered text query 610 “Generate code of sourcing application” into interface 600.

A query embedding is generated from the text query at S510. The query embedding is intended to represent the semantic meaning of the received text query. The query embedding may be generated by inputting the text query into a text embeddings model as described above. In some embodiments, the text embeddings model is the same text embeddings model (or encodes a semantic mapping which is similar to the embeddings model) used to generate embeddings for the vector database in process 200. Using similar text embeddings models ensures that similar embeddings are associated with similar semantic meanings.

Next, at S515, the query embedding is compared with stored embeddings of a vector database to identify stored embeddings which are similar to the query embedding. Any similarity measure may be used, including but not limited to cosine similarity, and any threshold may be used to determine whether two embeddings are considered “similar”. Some embodiments may cap the number of identified embeddings at a certain number N, so only the N most-similar embeddings are identified at S515. Another embodiment may include a re-ranker to the N-most similar retrieved embeddings to ensure that more-relevant embeddings are at the top-most of the retrieved embeddings list. The code and metadata (e.g., a summary of the code) associated with each identified embedding is retrieved. The retrieved code and metadata are intended to be relevant to the text query by virtue of their similar associated embeddings

According to some embodiments, S515 also includes comparison of the query embedding to previously-generated query embeddings which stored in a conversation store as described above. If any of the previously-generated query embeddings are determined to be similar to the query embedding, S515 may include retrieval of text generation model responses which are stored in association with the similar query embeddings.

A prompt is generated at S520. The prompt includes the text query and the code, metadata and any other information retrieved at S515. The prompt formulation for either code-generation or information-seeking queries follow a similar path. This similar pathway is possible because the code itself is not converted into embeddings, it is only added as a metadata. The embedding contains information about the code summary, code metadata across multiple hierarchies-grandparent, parent etc. This methodology enables query-type, agnostic retrieval from the code-vector database.

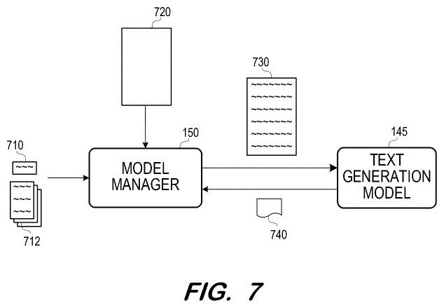

The prompt is transmitted to a text generation model at S525 and a response is received therefrom at S530. FIG. 7 illustrates S520-S530 according to some embodiments. Model manager 150 receives query 710 and retrieved code and metadata 712. Model manager 150 populates prompt template 720 with query 710 and code and metadata 712 to generate prompt 730 and transmits prompt 730 to text generation model 145. Model 145 returns response 740 to model manager.

According to some embodiments, the text generation model will indicate whether a returned response is complete. For example, if the response includes generated code, the generated code may consume the output token limit of the model before all the code requested by the prompt is generated. In such a case, the text generation model returns the so far-generated code and an indication that the response is incomplete.

If it is determined that the response is not complete, a next prompt is generated at S540. The next prompt includes the contents of the previous prompt. The next prompt also includes the received response (e.g., generated code) and an instruction to continue code generation from the end of the received response. The next prompt is transmitted to the text generation model at S525 and a next response is received at S530.

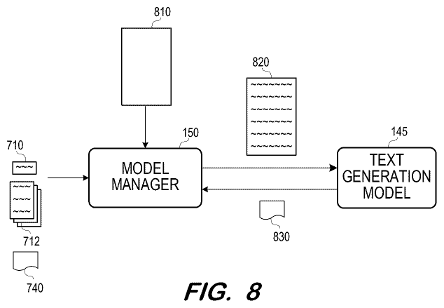

FIG. 8 illustrates S540, S525 and S530 as described above. At S540, model manager 150 populates prompt template 810 with query 710, code and metadata 712, and response 740 to generate prompt 820. Prompt template 810 includes an instruction to continue code generation from the end of response 740. Model manager 150 transmits prompt 820 to text generation model 145 and receives next response 830 in response. Flow may continue in this manner for several cycles until the response is determined to be complete at S535. At each instance of S540, a prompt is generated in which a last-received response is appended to the prior response (which may in turn be appended to the immediately-prior response, and so on).

Once the response is determined to be complete (e.g., a response is returned without an indication that the response is incomplete), a response is returned to the user at S545. The returned response is the concatenation of responses received at each execution of S530. These responses may be considered as incrementally-generated snippets of code which, when concatenated together, form the code which was requested by the user query. Embodiments may thereby leverage the significantly larger input token window of the text generation model to generate code which exceeds the output token limit of the text generation model.

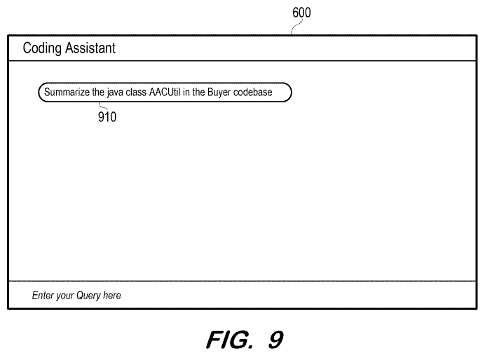

FIG. 9 illustrates user interface 600 including query 910. Query 910 requests a summary of a particular Java class. In response to query 910, a query embedding is generated at S510 and code and metadata are retrieved at S515 as described above. Next, a prompt is generated at S520 including the user query, the retrieved code and metadata. The prompt is transmitted to a text generation model at S525 and a response is received from the text generation model at S530. Since the user query is included in the prompt sent to the text generation model, the text generation model will determine whether to generate code or provide summaries in response. Assuming the received response is complete, the response is returned to the user at S545.

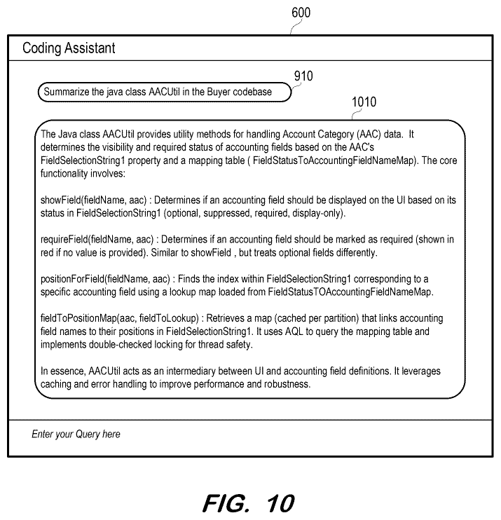

FIG. 10 illustrates returned response 1010 according to some embodiments. Response 1010 may comprise a summary of the class specified in query 910. The summary may have been generated as described above with respect to process 200. The summary may have been retrieved from a vector database at S515 by identifying a similarity between an embedding generated from query 910 and a stored embedding associated with the summary in the vector database.

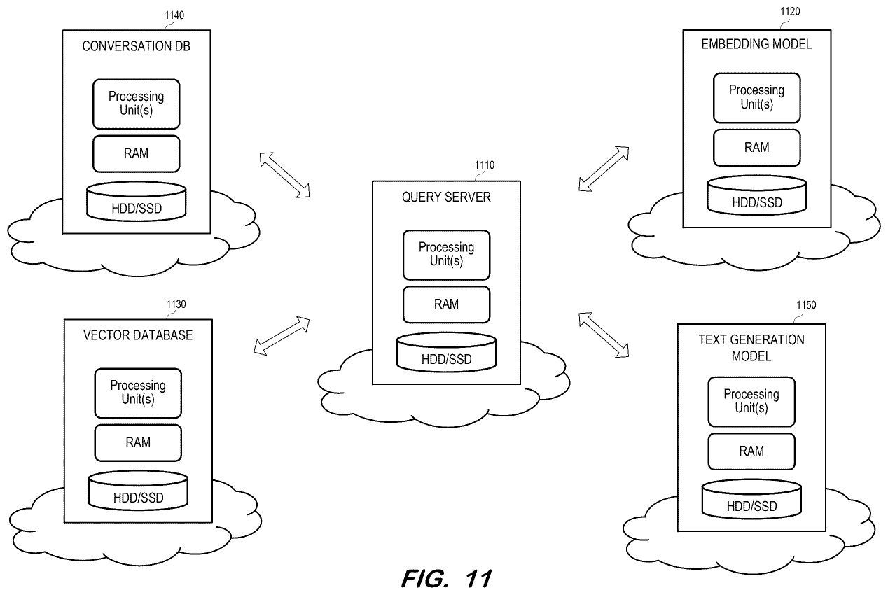

FIG. 11 is a diagram of a cloud-based implementation according to some embodiments. Each of systems 1110 through 1150 may comprise cloud-based resources residing in one or more public clouds providing self-service and immediate provisioning, autoscaling, security, compliance and identity management features. Each of systems 1110 through 1150 may comprise servers or virtual machines of respective Kubernetes clusters, but embodiments are not limited thereto.

Query server 1110 may receive a text query from a user (not shown) and request embedding model 1120 to generate a corresponding query embedding. Query server 1110 may search vector database 1130 and conversation database 1140 for information which is semantically similar to the text query based on the query embedding. Next, query server 1110 generates a prompt including the text query and the retrieved information and transmits the prompt to text generation model 1150.

Model 1150 may return a response along with an indication that the response is incomplete. Query server 1110 then generates a new prompt including the response and an instruction to resume response generation from an end of the response. The prompt-response cycle is repeated until the response is deemed complete.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable recording media. Such media may include, for example, a hard disk, a DVD-ROM, a Flash drive, magnetic tape, and solid-state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A method comprising:
receiving a text query from a user;
generating a first multi-dimensional numerical vector representing a semantic meaning of the text query;
identifying a second multi-dimensional numerical vector which is similar to the first multi-dimensional numerical vector;
determining a code portion and a summary of the code portion which are stored in association with the second multi-dimensional numerical vector;
generating a first prompt including the text query, the code portion and the summary of the code portion;
transmitting the first prompt to a text generation model;
receiving a first response to the first prompt from the text generation model, the first response comprising a first code snippet;
generating a second prompt including the text query, the code portion, the summary of the code portion and the first code snippet;
transmitting the second prompt to the text generation model;
receiving a second response to the second prompt from the text generation model, the second response comprising a second code snippet;
concatenating the first code snippet and the second code snippet; and
returning the concatenated first code snippet and second code snippet to the user.

2. The method of claim 1, wherein generating the second prompt comprises:
determining that the first response is incomplete and generating the second prompt in response to the determination that the first response is incomplete.

3. The method of claim 2, wherein the first response includes an indication that the first response is incomplete.

4. The method of claim 3, wherein the second response does not include an indication that the second response is incomplete.

5. The method of claim 1, wherein identifying the second multi-dimensional numerical vector comprises identifying a third multi-dimensional numerical vector which is similar to the first multi-dimensional numerical vector, and the method further comprising:
determining a second code portion and a second summary of the second code portion which are stored in association with the third multi-dimensional numerical vector,
wherein the first prompt includes the text query, the code portion, the summary of the code portion, the second code portion and the second summary of the second code portion, and
wherein the second prompt includes the text query, the code portion, the summary of the code portion, the second code portion, the second summary of the second code portion and the first code snippet.

6. The method of claim 5, further comprising:
acquiring the code portion;
prompting a second text generation model to generate a summary of the code portion;
generating the second multi-dimensional numerical vector based on the summary;
storing the second multi-dimensional numerical vector in association with the code portion and the summary of the code portion;
acquiring the second code portion;
prompting the second text generation model to generate the summary of the second code portion;
generating the third multi-dimensional numerical vector based on the second summary; and
storing the third multi-dimensional numerical vector in association with the second code portion and the second summary of the second code portion.

7. The method of claim 5, wherein the second prompt includes an instruction to generate code from an end of the first code snippet.

8. The method of claim 1, wherein the second prompt includes an instruction to generate code from an end of the first code snippet.

9. The method of claim 1, further comprising:
acquiring the code portion;
prompting a second text generation model to generate the summary of the code portion;
generating the second multi-dimensional numerical vector based on the summary; and
storing the second multi-dimensional numerical vector in association with the code portion and the summary of the code portion.

10. A system comprising:
a memory storing executable program code; and
at least one processing unit to execute the program code to cause the system to perform operations comprising:
receiving a text query;
generating a first multi-dimensional numerical vector based on the text query;
identifying a stored second multi-dimensional numerical vector which is similar to the first multi-dimensional numerical vector;
determining a code portion and a summary of the code portion associated with the second multi-dimensional numerical vector;
generating a first prompt including the text query, the code portion, the summary of the code portion and an instruction to generate code;
transmitting the first prompt to a text generation model;
receiving a first code snippet from the text generation model in response to the first prompt;
generating a second prompt including the text query, the code portion, the summary of the code portion, the first code snippet and the instruction to generate code;
transmitting the second prompt to the text generation model;
receiving a second code snippet from the text generation model in response to the second prompt;
concatenating the first code snippet and the second code snippet; and
returning the concatenated first code snippet and second code snippet.

11. The system of claim 10, wherein generating the second prompt comprises:
determining that the first response is incomplete and generating the second prompt in response to the determination that the first response is incomplete.

12. The system of claim 11, wherein the first response includes an indication that the first response is incomplete.

13. The system of claim 12, wherein the second response does not include an indication that the second response is incomplete.

14. The system of claim 10, wherein identifying the stored second multi-dimensional numerical vector comprises identifying a stored third multi-dimensional numerical vector which is similar to the first multi-dimensional numerical vector, and the operations further comprising:
determining a second code portion and a second summary of the code portion associated with the third multi-dimensional numerical vector,
wherein the first prompt includes the text query, the code portion, the summary of the code portion and an instruction to generate code, and
wherein the second prompt includes the text query, the code portion, the summary of the code portion, the first code snippet and the instruction to generate code.

15. The system of claim 14, the operations further comprising:
acquiring the code portion;
prompting a second text generation model to generate a summary of the code portion;
generating the second multi-dimensional numerical vector based on the summary;
storing the second multi-dimensional numerical vector in association with the code portion and the summary of the code portion;
acquiring the second code portion;
prompting the second text generation model to generate the summary of the second code portion;
generating the third multi-dimensional numerical vector based on the second summary; and
storing the third multi-dimensional numerical vector in association with the second code portion and the second summary of the second code portion.

16. The system of claim 14, wherein the second prompt includes an instruction to generate code from an end of the first code snippet.

17. The system of claim 10, wherein the second prompt includes an instruction to generate code from an end of the first code snippet.

18. The system of claim 10, further comprising:
acquiring the code portion;
prompting a second text generation model to generate the summary of the code portion;
generating the second multi-dimensional numerical vector based on the summary; and
storing the second multi-dimensional numerical vector in association with the code portion and the summary of the code portion.

19. One or more non-transitory computer-readable media storing program code, the program code executable by at least one processing unit of a computing system to cause the computing system to perform operations comprising:
receiving a text query;
generating a first multi-dimensional numerical vector based on the text query;
identifying a stored second multi-dimensional numerical vector which is similar to the first multi-dimensional numerical vector;
determining a code portion and a summary of the code portion associated with the second multi-dimensional numerical vector;
generating a first prompt including the text query, the code portion, the summary of the code portion and an instruction to generate code;
transmitting the first prompt to a text generation model;
receiving a first code snippet from the text generation model in response to the first prompt;
generating a second prompt including the text query, the code portion, the summary of the code portion, the first code snippet and the instruction to generate code;
transmitting the second prompt to the text generation model;
receiving a second code snippet from the text generation model in response to the second prompt;
concatenating the first code snippet and the second code snippet; and
returning the concatenated first code snippet and second code snippet.

20. The one or more non-transitory computer-readable media of claim 19, the operations further comprising:
acquiring the code portion;
prompting a second text generation model to generate the summary of the code portion;
generating the second multi-dimensional numerical vector based on the summary; and
storing the second multi-dimensional numerical vector in association with the code portion and the summary of the code portion.
